(19) United States
(12) Patent Application Publication
(10) Pub. No.: US 2016/0269410 A1
(43) Pub. Date: Sep. 15, 2016

(54) METHOD, SYSTEM AND DEVICE FOR NETWORK AUTHORIZATION BASED ON NO PASSWORD OR RANDOM PASSWORD

(71) Applicant: BEIJING QIHOO TECHNOLOGY COMPANY LIMITED, Beijing (CN)

(72) Inventor: Zhi LIU, Beijing (CN)

(73) Assignee: BEIJING QIHOO TECHNOLOGY COMPANY LIMITED, Beijing (CN)

(21) Appl. No.: 15/028,355

(22) PCT Filed: Aug. 26, 2014
(86) PCT No.: PCT/CN2014/085183

§ 371 Date: Apr. 8, 2016

(30) Foreign Application Priority Data
Oct. 9, 2013 (CN) 201310467457.9

(51) Int. Cl. H04L 29/06; H04W 12/08; H04W 12/06

(52) U.S. Cl. CPC H04L 63/10; H04L 63/083; H04W 12/06; H04W 12/08

(57) ABSTRACT

Disclosed are a method, system and device for network authorization based on no password or a random password, the method comprising: a network access device receives a connection establishment request message, and performs a consult operation according to the connection establishment request message, the consult operation comprising: the network access device generates a consult message containing the physical address information of a main control device and the information of whether a terminal device is allowed to access a network, and transmits the consult message to a server, the physical address information of the main control device being pre-stored in the network access device; the server generates a consult notification, and transmits the consult notification to the main control device; the main control device prompts a user, according to the consult notification, whether the terminal device is allowed to access the network, and generates and transmits, according to user input information, an instruction notification comprising instruction information; and if the network access device determines according to the instruction information from the main control device that the terminal device is allowed to access the network, then the network access device performs a network access operation; otherwise, the network access device rejects the access operation.

### CROSS-REFERENCE TO RELATED APPLICATIONS

This application is a national stage of International Application No. PCT/CN2014/085183, filed Aug. 26, 2014, which is based upon and claims priority to Chinese Patent Applications No. CN201310467457.9, filed Oct. 9, 2013, the entire contents of all of which are incorporated herein by reference.

### FIELD OF TECHNOLOGY

The present invention relates to the field of network access technology and, more particularly, to a method, system and device for network authorization based on no password or random password.

### BACKGROUND

Currently, user equipment especially mobile terminals are usually access to network by network access devices (such as wireless router devices), such as accessing the Internet or LAN in wireless way.

Hereinafter, supposing the user equipment is a mobile terminal and the network access device is a wireless router device, the way that the present user equipment accesses the network by the network access device is illustrated.

First, the mobile terminal searches and finds the wireless router device, and establishes wireless connection with the wireless router device, afterwards, if the wireless router device determines that the mobile terminal has the access right, it makes the mobile terminal to access the network, or it requires the mobile terminal to input user name and password; afterwards, the wireless router device validates whether the user name and password input by the mobile terminal is correct according to the pre-stored user name and password, if it is correct, the wireless router device allows the mobile terminal to access the network, otherwise it rejects the mobile terminal to access the network.

In some circumstance, there are usually requirements for temporarily accessing the network, such as having visitors at home or having clients in office. The accessed people such as visitor or client may have the requirement of accessing the network. There are usually several ways used to satisfy the requirement:

As the first way, it is capable to provide the user name and password of the host to the accessor such as the guest or visitor, the accessor may access the network according to the user name and password.

As the second way, the wireless router device has the capability of providing guest network, that is, the wireless router device establishes a new wireless hotspot and assign user name and password for the new wireless hotspot, the accessor such as the visitor or guest may access the network according to the user name and password.

As a specific example, the wireless router device establishes two wireless hotspot, one of which is specifically used for guest network, the other is used for home network, the wireless router device is disposed as two Vlan (Virtual Local Area Network) which are named Vlan0 and Vlan1, the accessor such as visitor or guest may use the guest network to access network by the user name and password of Vlan0. In addition, the wireless router device may reject the user in the guest network to login home network by setting separate network segment.

As the third way, using Wps (Wi-Fi Protected Setup) to achieve the objective. That is, triggering the Wps in the wireless router device and mobile terminal which needs to access the network, and waiting the connection between the wireless router device and the mobile terminal, and then the mobile terminal directly accesses the network.

In finishing the invention, the inventor finds that the first way above needs the accessor to input the user name and password, and even to the internet TV at home, if it needs to access the network, it also needs to input user name and password. Therefore, the operation of the accessor such as the visitor or guest performed to access the network is not convenient, the user needs to remember the user name and password; in addition, it is a hidden danger to provide the user name and password of the host externally; the second way above also needs the user to input user name and password, therefore, it also has the problem of accessing the network inconveniently; the third way above is not capable to set guest right of wireless connection based on Wps, it may have safety hidden danger in a certain extent; in addition, there are only a few devices supporting Wps function, which limits the applied range in a certain extent.

### SUMMARY

In light of the above problems, the present invention provides a method for network authorization based on no password or random password and the corresponding system and device for network authorization based on no password or random password, to overcome the problem above or at least partially solve the problem above.

According to an aspect of the invention, there is provided a method for network authorization based on no password or a random password, comprising: a network access device receiving a connection establishment request message from a terminal device; the network access device performing a consult operation according to the connection establishment request message, the consult operation including: the network access device generating a consult message including physical address information of a main control device and information of whether a terminal device is allowed to access a network, and transmitting the consult message to a server connected to the network access device, the physical address information of the main control device being pre-stored in the network access device; the server generating a consult notification according to the received consult message, and sending the consult notification to the main control device; the main control device prompting a user whether the terminal device is allowed to access the network according to the consult notification, after receiving the consult notification, and generating and sending an instruction notification including instruction information according to user input information, the instruction information including physical address information of the terminal device and information of whether allowing to access the network; if the network access device determines that the terminal device is allowed to access the network according to the instruction information from the main control device, performing a network access operation; if the network access device determines that the terminal device is rejected to access the network, performing a rejecting access operation.

According to another aspect of the invention, there is provided A network authorization system based on no password or random password, comprising: a receiving module, disposed in a network access device, configured to receive a connection establishment request message from a terminal device, a consulting module, disposed in the network access device, configured to perform a consult operation according to the connection establishment request message, the consult operation including: the network access device generating a consult message including physical address information of a main control device and information of whether a terminal device is allowed to access a network, and transmitting the consult message to a server connected to the network access device, the physical address information of the main control device being pre-stored in the network access device; a notification module, disposed in a server, configured to generate a consult notification according to the received consult message, and send the consult notification to the main control device; a prompting module, disposed in the main control device, configured to prompt a user whether the terminal device is allowed to access the network according to the consult notification after the main control device receives the consult notification; an authorization module, disposed in the main control device, configured to generate an indication notification including instruction information according to a user input information, the instruction information including the physical address information of the terminal device and information of whether allowing to access the network; a sending module, disposed in the main control device, configured to send the indication notification; an access control module, disposed in the network access device, configured to perform a network access operation if it is determined that the terminal device is allowed to access the network according to the instruction information from the main control device, and perform a rejecting access operation if the network access device determines that the terminal device is rejected to access the network.

According to still another aspect of the invention, there is provided a network authorization method based on no password or random password comprising: a network access device receiving a connection establishment request message from a terminal device, the network access device performing a consult operation according to the connection establishment request message, the consult operation including: the network access device generating a consult message including physical address information of a main control device and information of whether the terminal device is allowed to access a network, and sending the consult message to a server connected to the network access device, the physical address information of the main control device being pre-stored in the network access device, the information carried in the consult message being transmitted to the main control device via the server; if the network access device determines that the terminal device is allowed to access the network according to the instruction information from the main control device, performing a network access operation; if the network access device determines that the terminal device is rejected to access the network, performing a rejecting access operation.

According to still another aspect of the invention, there is also provided A network access device comprising: a receiving module, configured to receive a connection establishment request message from a terminal device, a consulting module, configured to perform a consult operation according to the connection establishment request message, the consult operation including: generating a consult message including physical address information of a main control device and information of whether a terminal device is allowed to access a network, and sending the consult message to a server connected to the network accessing device, the physical address information of the main control device being pre-stored in the network access device, the information carried in the consult message being transmitted to the main control device via the server; an access control module, configured to perform a network access operation if it is determined that the terminal device is allowed to access the network according to the instruction information from the main control device, and perform a rejecting access operation if the network access device determines that the terminal device is rejected to access the network.

According to still another aspect of the invention, there is provided a network authorization method based on no password or random password, comprising: a main control device prompting a user whether a terminal device is allowed to access a network after receiving a consult notification from a server, the consult notification being generated by the server according to the consult message from the network access device; the main control device generating an indication notification including the instruction information according to user input information, the instruction information including: physical address information of the terminal device and the information of whether allowing to access the network; the main control device sending the indication notification to make the network access device perform network access operation when the network access device determines the terminal device is allowed to access the network according to the instruction information from the main control device, and performing a rejecting access operation when the network access device determines the terminal device is rejected to access the network.

According to still another aspect of the invention, there is provided a main control device comprising: a prompting module, configured to prompt a user whether a terminal device is allowed to access a network according to a consult notification after the main control device receive the consult notification from a server; an authorization module, configured to generate an indication notification including instruction information according to user input information, the instruction information including physical address information of the terminal device and information of whether allowing to access the network; a sending module, configured to send the indication notification to make the network access device perform a network access operation if it is determined that the terminal device is allowed to access the network according to the instruction information from the main control device, and perform a rejecting access operation if the network access device determines that the terminal device is rejected to access the network.

In the method, device and system for network authorization based on no password or random password according to the embodiment of the invention, it is capable to consult a main control device whether a terminal device can be accessed to the network for a terminal device which does not have access right, and after the network access device obtains the permission form then main control device, it may allow the terminal device to access the network without requiring the terminal device to input user name and password. Therefore, the problem that the terminal device cannot access the network conveniently and the user needs to remember the user name and password is solved, and the problem that the user name and password are provided to the guest and the problem that the safety hidden danger caused by the access right of the terminal device cannot be limited are avoided, and the invention further has the beneficial of being easy to be spread.

The above descriptions are merely an overview of technical solutions of the present invention. In order to be able to understand the technical solutions of the present invention more clearly and able to implement according to the content of the descriptions, also in order to make the above and other purposes, features and advantages of the invention more apparent and easy to understand, detailed embodiments of the invention will be provided below.

### BRIEF DESCRIPTION OF THE DRAWINGS

Through reading the detailed description of the following preferred embodiments, various other advantages and benefits will become apparent to an ordinary person skilled in the art. Accompanying drawings are merely included for the purpose of illustrating the preferred embodiments and should not be considered as limiting of the invention. Further, throughout the drawings, same elements are indicated by same reference numbers. In the drawings:

FIG. 1 is a flow chart of the network authorization method based on no password or random password according to an embodiment of the invention;

FIGS. 2A, 2B and 2C are schematic diagrams of the network authorization method based on no password or random password according to an embodiment of the invention;

FIG. 3 is a block diagram of the network authorization system based on no password or random password according to an embodiment of the invention;

FIG. 4 is a block diagram illustrating a communicating device for executing the method according the invention; and

FIG. 5 is a schematic diagram of a memory cell which is used to store and carry program codes for realizing the method according to the invention.

### DESCRIPTION OF THE EMBODIMENTS

Exemplary embodiments of the present disclosure will be described in more detail with reference to the accompanying figures hereinafter. Although the exemplary embodiments of the disclosure are illustrated in the accompanying figures, it should be understood that the disclosure may be embodied in many different forms and should not be construed as being limited to the embodiments set forth herein. Rather, these embodiments are provided so that this disclosure will be understood thoroughly and completely and will fully convey the scope of the disclosure to those skilled in the art.

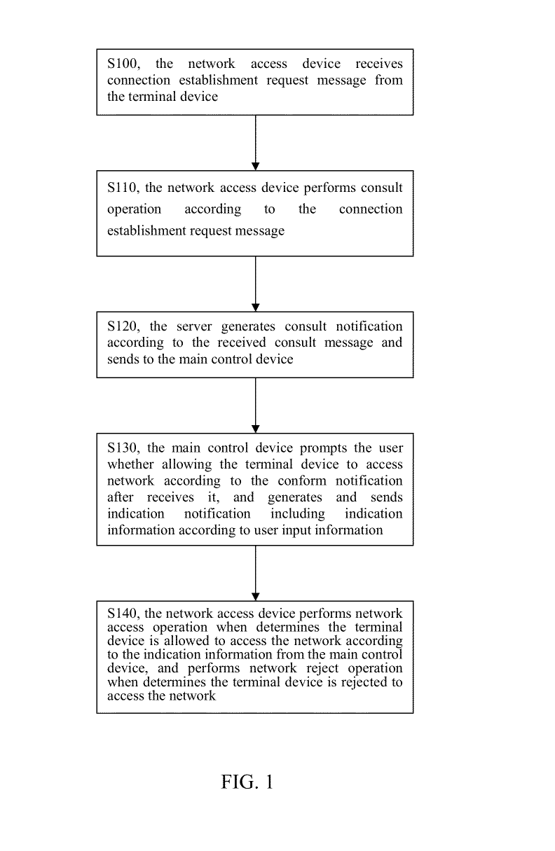

The first embodiment is a network authorization method based on no password or random password. The flow path of the method is shown in FIG. 1.

Specifically, the terminal device may be a smart mobile phone, a tablet computer or a computer (such as notebook computer). The terminal device is usually an accessor which needs to access the network temporarily (such as the visitor at home or a guest in the office), the accessor may also be accessors with other forms such as internet TV at home. The network access device may be a route device (such as an enterprise-level wired router device or a home-level wired router device and so on) especially a wireless router device (such as a home-level wireless router device or an enterprise-level wireless router device and so on), and it may also be an exchange (such as a home-level exchange or an enterprise-level exchange and so on) and other devices.

The network access device may have a login password, and it may also have no login password. If the network access device does not have the login password, to avoid interruption from irrelative accessor (such as neighbors), the network access device may claim to the external that it has the login password by broadcast way. Thus, usually the irrelative accessors do not attempt to access the network through the network access device.

If the network access device is a wireless router device, the terminal device may send a connection establishment request message to the network access device corresponding to its selected wireless access hotspot after it searches the wireless access hotspot, to establish a wireless connection with the network access device.

S110, the network access device performing a consult operation according to the connection establishment request message.

Specifically, the network access device may perform the consult operation when it determines the terminal device does not have access right according to a physical address information of the terminal device carried in the connection establishment request message, the physical address information of the terminal device may be information for indicating a physical device uniquely, the physical address information of the terminal device is usually the MAC (media access control) address information.

The network access device may determine whether it needs to perform the consult operation according to its pre-stored information (such as a black list) and the physical address information of the terminal device carried in the connection establishment request message, if the network access device determines that the terminal device is not the customer that is rejected to access the network, and the terminal device is not the customer that is allowed to access the network, the network access device determines the terminal device does not have the access right (that is the network access right is unknown/not clear), it needs to perform the consult operation; if the network access device determines that the terminal device is the customer that is rejected to access the network (such as the user in the black list), the network access device may directly reject the terminal device from accessing the network.

The consult operation performed by the network access device includes: the network access device generating a consult message, and transmitting the consult message to a server connected to the network access device, the connection between the network access device and the server is a keep-alive connection, the information carried in the consult message mainly includes: physical address information of a main control device and information of whether a terminal device is allowed to access a network; optionally, the consult message may also carry the host name of the terminal device and the type information of the terminal device and so on. The information whether the terminal device is allowed to access the network may include: the physical address information of the terminal device and a consulting flag bit. The physical address information of the main control device is usually pre-stored in the network access device, for example, stored in the network access device by ways such as registration.

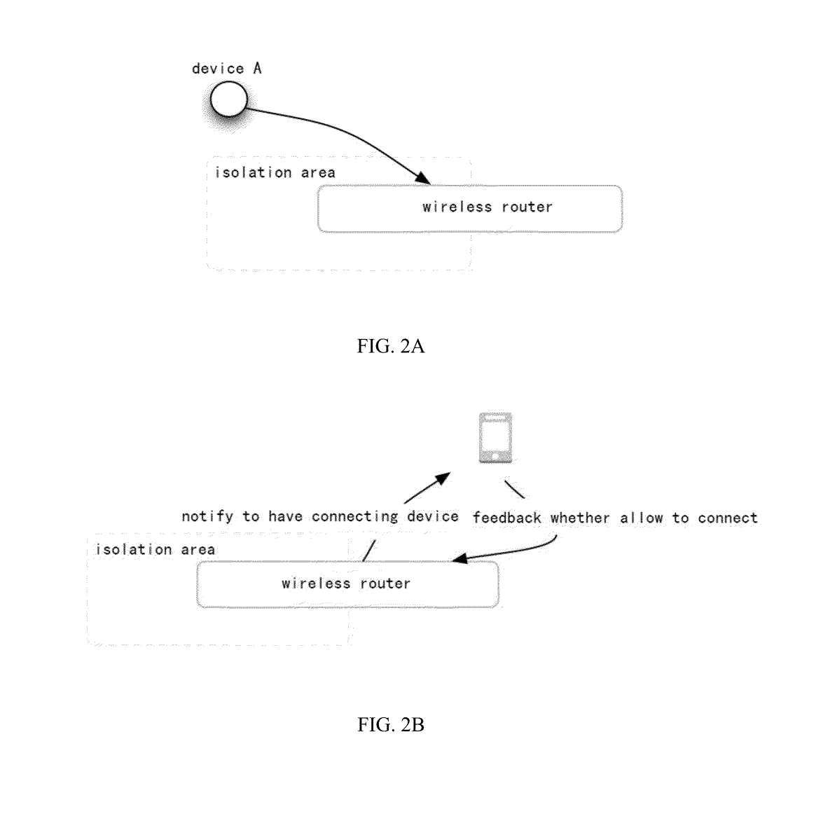

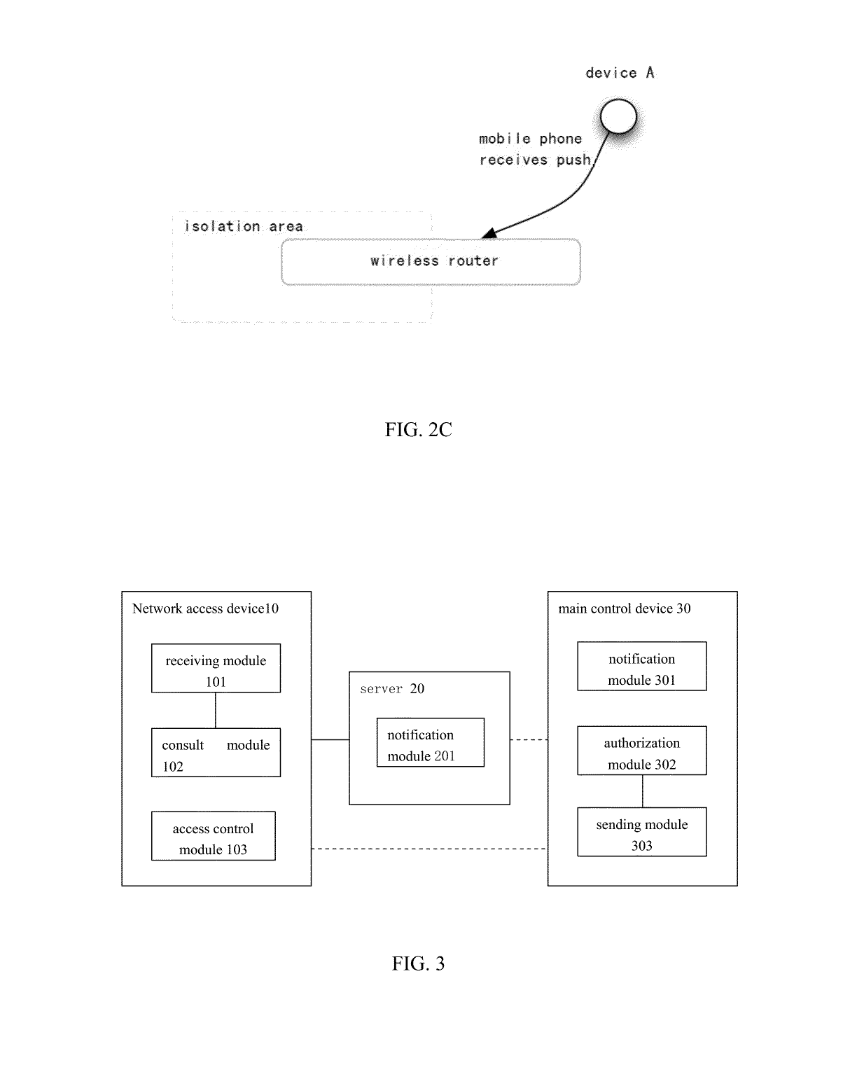

In addition, the consult operation performed by network access device may further include: assigning a network address for the terminal device, and the network address should belong to a network segment of the isolation area which cannot access the Internet (the network access device supports SSID (service set identifier)), as shown in FIG. 2A. The device A in FIG. 2A is the terminal device, and the wireless router in FIG. 2A is the network access device.

S120, after the server receives the consult message, it generates the consult message according to the consult message, and sends the consult notification to the corresponding main control device, as shown by the arrow at the left side of FIG. 2B (the server is not shown in FIG. 2B, the mobile phone in FIG. 2B is the main control device).

Specifically, the server may determine which main control device should the consult notification be sent to according to the physical address information of the main control device carried in the consult message, the consult notification should carry the physical address information of the terminal device and the information of whether the terminal device is allowed to access the network, the consult notification may also carry the host name of the terminal device and the type information of the terminal device, to allow the main control device to possibly know more about the information of the terminal device which attempts to access the network.

The server may send the consult notification to the main control device by message based on network data (such as QQ message) or short message (that is text message or multimedia message) or by Email.

The main control device in the embodiment of the invention may specifically a mobile phone (such as smart mobile phone) or tablet computer or computer (such as notebook computer) and so on.

It should be noted that, after the server receives the consult message, it may determine whether it needs to send the consult notification to the main control device according to the consult message according to its stored information (such as a black list stored therein), a specific example is, the server may store the physical address information of the terminal device and information of network access device (such as the physical address information of the network access device) which is rejected to access the network by the main control device according to the indication notification that is used to be sent by the main control device. Thus the server may take the stored information as a reference of whether it should send the consult notification to the main control device when the terminal device attempts to access the network via the network access device to make the server receive the consult message. If the time that the terminal device is rejected to access the network by the main control device exceeds a predetermined time, even if the server receives the consult message sent from the network access device, it does not send the consult notification to the main control device, instead, it directly sends information of rejecting the terminal device from accessing to network access device.

S130, the main control device prompts the user whether the terminal device is allowed to access the network after it receives the consult notification sent by the server, and generates the indication notification including the instruction information according to the user input information, then, the main control device sends the indication notification.

Specifically, the main control device may inform the user it receives the consult notification by popping out windows or scrolling captions, the user therefore may see the detailed content of the consult notification to know there are terminal device attempting to access the network via the network access device. If the consult notification carries the host name of terminal device and the type information of the terminal device, they are shown to the user together, to make the user know the terminal device more clearly.

The user may input corresponding information (such as Y or N) to represent whether he or she allows the terminal device to access the network. The instruction information in the indication notification generated by the main control device mainly includes: the physical address information of the terminal device and the allow/reject to access the network information represented in the user input information, the physical address information of the terminal device may be obtained from the received consult notification of the main control device.

When the main control device does not directly connected to the network access device, the main control device may send the indication notification to the server, and then indication message may be generated by the server according to the instruction information carried in the indication notification, afterwards, the server sends the indication message to the network access device (as shown by the arrow at the right of FIG. 2B, and the server is not shown in FIG. 2B). Obviously, when the main control device is directly connected to the network access device, it is also capable to use the above way of server transferring.

The way that the main control device sends the indication notification to the server is preferable the same as the way that the server sends the consult notification to the main control device, if the server sends the consult notification to the main control device by short message, the main control device should also send the indication notification to the server via short message.

When the main control device is directly connected to the network access device, the main control device may send the indication notification to the network access device directly (as shown in FIG. 2C), and the main control device should consider whether the indication notification can be parsed successfully by the network access device when it generates the indication notification.

S140, the network access device performs network access operation after determining the terminal device is allowed to access the network according to the instruction information of the main control device, and performs the rejecting access operation after determining the terminal device is rejected to access the network.

Specifically, the network access device may obtain the instruction information from the information carried by the indication message/indication notification, no matter it receives the indication message sent from the server and the indication notification sent from the main control device, the network access device may clearly know whether the main control device allows the terminal device to access the network by parsing the obtained instruction information, if the main control device allows the terminal device to access the network, the network access device may use different ways to access the terminal device into the terminal device, for example, the network access device makes the terminal device access the network, and isolate the terminal device in the isolation area range. At that moment, the terminal device can still use the network address belonging to the isolation area assigned to it originally, but the network access device no longer rejects the network address from accessing the network; in another example, the network access device makes the terminal device to access the network and does not isolate the terminal device in the isolation area, at that moment, the terminal device can still use the network address belonging to the isolation area assigned to it originally, but the network access device does not specify the network address to the isolation area. Obviously, the network access device may also assign the network address again for the terminal device, thusly, the terminal device may have the same network accessing right with the main control device, for example, the terminal device may visit home network.

If the main control device rejects the terminal device from accessing the network, the network access device may store the physical address information of the terminal device when it does not perform the accessing network operation, therefore, when the terminal device tries to access the network via the network access device the next time, the information may be used as a reference of whether the network access device should consult to the main control device, if the time that the terminal device is rejected by the main control device from accessing the network via the network access device reaches a predetermined time, the network access device may add the terminal device in the black list, then the consult message of whether the terminal device can access the network is not sent.

The second embodiment is a network authorization system based on no password or random password, the structure of the system is shown in FIG. 3.

The network authorization system shown in FIG. 3 main includes: a network access device 10, a server 20 and a main control device 30. Wherein the server 20 is connected to the network access device 10 and the main control device 30 respectively, and the main control device 30 may directly connect the network access device 10.

The network access device 10 includes: a receiving module 101, a consulting module 102 and an access controlling module 103. The server 20 includes a notification module 201; the main control device includes a prompting module 301, an authorization module 302 and a sending module 303. Wherein the network access device 10 may further includes a broadcast module (not shown in FIG. 3).

It should be noted that, in the embodiment, only a server 20, a network access device 10 and a main control device 30 are taken as an example, in practical application, a server 20 may connect multiple network access devices 10 and multiple main control devices 30 at the same time.

The network access device 10 may be a router device especially a wireless router device (such as a home-level wireless router device or an enterprise-level wireless router device and so on), and it may also be an exchange (such as home-level exchange or a enterprise-level exchange and so on) and other devices; in addition, the network access device 10 may have login password and may have no login password. When the network access device 10 does not have login password, the broadcast module (not shown in FIG. 3) in the network access device 10 may claim to the external that it has login password by broadcast way. Thus, usually the irrelative accessors do not attempt to access the network through the network access device.

The receiving module 101 is connected to the consulting module 102, the receiving module 101 is mainly used to receive the connection establishment request message from the terminal device (such as the smart mobile phone, tablet computer, computer or smart internet TV and so on).

The consulting module 102 is mainly used to obtain the physical address information of the terminal device from the connection establishment request message from the receiving module 101, and perform the consult operation when it determines the terminal device does not have access right according to the physical address information of the terminal device.

Specifically, the physical address information of the terminal device may be information for indicating a physical device uniquely, the physical address information of the terminal device is usually the MAC (media access control) address information.

The consulting module 102 may determine whether it needs to perform the consult operation according to its pre-stored information (such as the black list) and the physical address information of the terminal device carried in the connection establishment request message, if the consulting module 102 determines that the terminal device is not the customer that is rejected to access the network, and the terminal device is not the customer that is allowed to access the network, the consulting module 102 determines the terminal device does not have the access right (that is the network access right is unknown/not clear), it needs to perform the consult operation; if the consulting module 102 determines that the terminal device is the customer that is rejected to access the network (such as the user in the black list), the consulting module 102 may directly reject the terminal device from accessing the network.

The consult operation performed by the consulting module 102 mainly includes: the consulting module 102 generating a consult message, and transmitting the consult message to a server 20 connected to the network access device which in the consulting module 102 belongs to, the connection between the network access device 10 and the server 20 is usually a keep-alive connection, the information carried in the consult message mainly includes: physical address information of a main control device and information of whether a terminal device is allowed to access a network; optionally, the consult message may also carry the host name of the terminal device and the type information of the terminal device and so on. The information whether the terminal device is allowed to access the network may include: the physical address information of the terminal device and a consulting flag bit.

In addition, the consult operation performed by consulting module 102 may further include: assigning a network address for the terminal device, and the network address should belong to a network segment of the isolation area which cannot access the Internet.

The notification module 201 is mainly used to generate consult notification according to the information carried in the consult message received by the server 20, and send the consult notification to the main control device.

Specifically, the notification module 201 may determine which main control device 30 should the consult notification be sent to according to the physical address information of the main control device carried in the consult message, the consult notification should carry the physical address information of the terminal device and the information of whether the terminal device is allowed to access the network, the consult notification may also carry the host name of the terminal device and the type information of the terminal device, to allow the main control device 30 to possibly know more about the information of the terminal device which attempts to access the network.

The notification module 201 may send the consult notification to the main control device by message based on network data (such as QQ message) or short message (that is text message or multimedia message) or by Email.

It should be noted that, after the server 20 receives the consult message, the notification module 201 may determine whether it needs to send the consult notification to the main control device 30 according to the consult message according to the information stored in the server 20 (such as a black list), a specific example is, the server 20 may store the physical address information of the terminal device and information of network access device 10 (such as the physical address information of the network access device 10) which is rejected to access the network by the main control device 30 according to the indication notification that is used to be sent by the main control device. Thus the notification module 201 may take the information stored in the server 20 as a reference of whether it should send the consult notification to the main control device 30 when the terminal device attempts to access the network via the network access device to make the server receive the consult message. If the time that the terminal device is rejected to access the network by the main control device 30 exceeds a predetermined time, even if the server receives the consult message sent from the network access device 10, the notification module 201 does not send the consult notification to the main control device 30, instead, it directly sends information of rejecting the terminal device from accessing to network access device.

The prompting module 301 is mainly used to prompt the user whether the terminal device is allowed to access the network after the server 20 receives the consult notification sent by the server.

Specifically, the notification module 301 may inform the user the main control device 30 receives the consult notification by popping out windows or scrolling captions, the user therefore may see the detailed content of the consult notification to know there are terminal device attempting to access the network via the network access device. If the consult notification carries the host name of terminal device and the type information of the terminal device, they are shown to the user together by the notification module 301, to make the user know the terminal device more clearly.

The authorization module 302 is connected to the sending module 301, the authorization module 302 is mainly used to generate the indication notification including the instruction information according to the user input information.

The user may input corresponding information (such as Y or N) to represent whether he or she allows the terminal device to access the network. The instruction information in the indication notification generated by the authorization module 302 mainly includes: the physical address information of the terminal device and the allow/reject to access the network information represented in the user input information, the physical address information of the terminal device may be obtained by the authorization module 302 from the consult notification received by the main control device.

The sending module 303 is mainly used to send the indication notification generated by the authorization module 302.

Specifically, When the main control device 30 does not directly connected to the network access device 10, the sending module 30 may send the indication notification to the server 20, and then indication message may be generated by the notification module 201 of the server 20 according to the instruction information carried in the indication notification, afterwards, the notification module 301 sends the indication message to the network access device 10. Obviously, when the main control device 30 is directly connected to the network access device 10, it is also capable to use the above way of server 20 transferring.

The way that the sending module 303 sends the indication notification to the server is preferable the same as the way that the notification module 201 of the server 20 sends the consult notification to the main control device 30, if the server 20 sends the consult notification to the main control device 30 by short message, the sending module 303 should also send the indication notification to the server 20 via short message. That is, when the authorization module 302 generates the indication notification, it should consider the sending way of the consult notification.

When the main control device 30 is directly connected to the network access device 10, the sending module 303 may send the indication notification to the network access device 10 directly. That is, the authorization module 302 should consider whether the indication notification can be parsed successfully by the network access device when it generates the indication notification.

The access control module 103 is mainly used to perform the network access operation when it is determined the terminal device is allowed to access the network, and perform the reject access operation when it is determined the terminal device is rejected to access the network according to the instruction information of the main control device.

Specifically, the access control module 103 may obtain the instruction information from the information carried by the indication message/indication notification, no matter the network access device 10 receives the indication message sent from the server 20 and the indication notification sent from the main control device 30, the access control module 103 may clearly know whether the main control device 30 allows the terminal device to access the network by parsing the obtained instruction information, if the main control device 30 allows the terminal device to access the network, the access control module 103 may use different ways to access the terminal device into the terminal device, for example, the access control module 103 makes the terminal device access the network, and isolate the terminal device in the isolation area range. In another example, the access control module 103 makes the terminal device access the network and does not isolate the terminal device in the isolation area, at that moment, the terminal device can still have the same network accessing right with the main control device 30, for example, the terminal device may visit home network.

If the main control device 30 rejects the terminal device from accessing the network, the network access device may store the physical address information of the terminal device at the same time it does not perform the accessing network operation, therefore, when the terminal device tries to access the network via the network access device 10 the next time, the information may be used as a reference of whether the network access device 10 should consult to the main control device 30, if the time that the terminal device is rejected by the main control device 30 from accessing the network via the network access device 10 reaches a predetermined time, the access control module 103 may add the terminal device in the black list, then the consulting module 102 does not send the consult message of whether the terminal device can access the network.

Algorithm and display provided herein are not inherently related to a particular computer, virtual system or other equipment. Various general systems may also be used with the teaching based on the disclosure. According to the above description, the required structure for constructing such a system is obvious. In addition, the disclosure is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

Similarly, it should be understood that, in order to simplify the disclosure and to facilitate the understanding of one or more of various aspects thereof, in the above description of the exemplary embodiments of the disclosure, various features of the disclosure may sometimes be grouped together into a single embodiment, accompanying figure or description thereof. However, the method of this disclosure should not be constructed as follows: the disclosure for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the disclosure.

It should be understood by those skilled in the art that modules of the device in the embodiments can be adaptively modified and arranged in one or more devices different from the embodiment. Modules in the embodiment can be combined into one module, unit or component, and also can be divided into more sub-modules, sub-units or sub-components. Except that at least some of features and/or processes or modules are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the disclosure and forms the different embodiment. For example, in the claims, any one of the embodiments for which the protection is sought can be used in any combination manner.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the network accessing device, server and main control device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

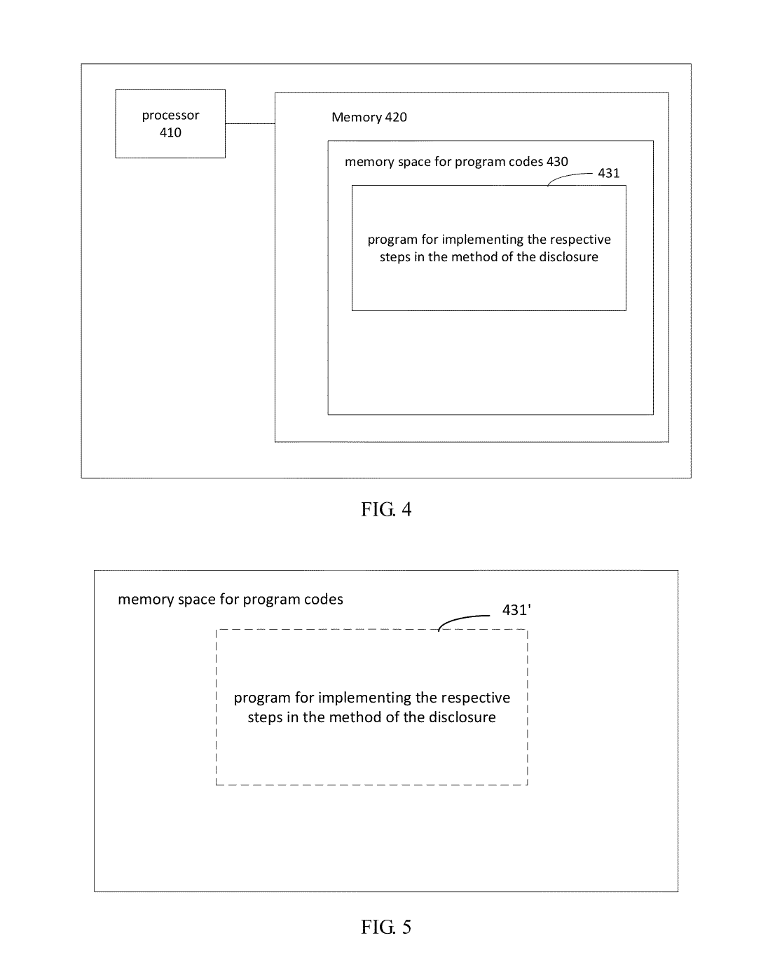

For example, FIG. 4 illustrates a block diagram of a communicating device of the network authorization method based on no password or random password. Traditionally, the electronic apparatus includes a processor 410 and a computer program product or a computer readable medium in form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the communication device as shown in FIG. 4. The program codes may be compressed for example in an appropriate form. Usually, the memory cell includes computer readable codes 431′ which can be read for example by processors 410. When these codes are operated on the communication device, the communication device may execute respective steps in the method as described above.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

1.-8. (canceled)

9. A network authorization system based on no password or random password, comprising a network access device, a server and a main control device,
the network access device including:
a first memory having instructions stored thereon:
a first processor configured to execute the instructions to perform network authorization, comprising:
receiving a connection establishment request message from a terminal device,
performing a consult operation according to the connection establishment request message, the consult operation including: the network access device generating a consult message including physical address information of a main control device and information of whether a terminal device is allowed to access a network, and transmitting the consult message to a server connected to the network access device, the physical address information of the main control device being pre-stored in the network access device;
performing a network access operation if it is determined that the terminal device is allowed to access the network according to instruction information from the main control device, and perform a rejecting access operation if the network access device determines that the terminal device is rejected to access the network;
the server including;
a second memory having instructions stored thereon;
a second processor configured to execute the instructions to perform network authorization, comprising:
generating a consult notification according to the received consult message, and sending the consult notification to the main control device;
the main control device including:
a third memory having instructions stored thereon;
a third processor configured to execute the instructions to perform network authorization, comprising:
prompting a user whether the terminal device is allowed to access the network according to the consult notification after the main control device receives the consult notification;
generating an indication notification including instruction information according to a user input information, the instruction information including the physical address information of the terminal device and information of whether allowing to access the network;
and sending the indication notification to the network access device.

10.-15. (canceled)

16. A network access device comprising:
a first memory having instructions stored thereon;
a first processor configured to execute the instructions to perform network authorization, comprising:
receiving a connection establishment request message from a terminal device,
performing a consult operation according to the connection establishment request message, the consult operation including: generating a consult message including physical address information of a main control device and information of whether a terminal device is allowed to access a network, and sending the consult message to a server connected to the network accessing device, the physical address information of the main control device being pre-stored in the network access device, the information carried in the consult message being transmitted to the main control device via the server;
performing a network access operation if it is determined that the terminal device is allowed to access the network according to the instruction information from the main control device, and perform a rejecting access operation if the network access device determines that the terminal device is rejected to access the network.

17. The device according to claim 16, wherein the first processor is further configured to assign a network address for the terminal device, and the network address belonging to the network segment in an isolation area which cannot access the Internet.

18. The device according to claim 16, wherein the network access device has a login password or does not have the login password;
first processor is further configured to perform:
claiming to the external that it has the login password by broadcasting when the network access device does not have the login password.

19. The device according to claim 16, wherein the consult message further comprises: a host name of the terminal device or the type of the terminal device, and the host name of the terminal device or the type of the terminal device is transmitted to the main control device via the server.

20. The device according to claim 16, wherein, performing the network access operation comprises:
connecting the terminal device into network, and isolating the terminal device in the isolation area; or
connecting the terminal device into network, and not isolating the terminal device to in isolation area.

21.-23. (canceled)

24. A main control device comprising:
a third memory having instructions stored thereon;
a third processor configured to execute the instructions to perform network authorization, comprising:
prompting a user whether a terminal device is allowed to access a network according to a consult notification after the main control device receive the consult notification from a server;
generating an indication notification including instruction information according to user input information, the instruction information including physical address information of the terminal device and information of whether allowing to access the network;
sending the indication notification to make the network access device perform a network access operation if it is determined that the terminal device is allowed to access the network according to the instruction information from the main control device, and performing a rejecting access operation if the network access device determines that the terminal device is rejected to access the network.

25. The device according to claim 24, wherein the consult notification is transmitted to the main control device by instant message, short message or Email from the server.

26. The device according to claim 24, wherein the third processor is further configured to perform: when the main control device is directly connected to the network access device, directly sending the indication notification to the network access device; or
sending the indication notification to the server, to make the server generate an indication message according to the instruction information carried in the indication notification and sends the indication message to the network access device.

27.-28. (canceled)

29. The system according to claim 9, wherein,
the first processor is further configured to perform:
receiving a connection establishment request message from a terminal device;
performing a consult operation according to the connection establishment request message, the consult operation including: the network access device generating a consult message including physical address information of a main control device and information of whether a terminal device is allowed to access a network, and transmitting the consult message to a server connected to the network access device, the physical address information of the main control device being pre-stored in the network access device;
if the network access device determines that the terminal device is allowed to access the network according to the instruction information from the main control device, performing a network access operation; if the network access device determines that the terminal device is rejected to access the network, performing a rejecting access operation;
the second processor is further configured to perform:
generating a consult notification according to the received consult message, and sending the consult notification to the main control device;
the third processor is further configured to perform:
prompting a user whether the terminal device is allowed to access the network according to the consult notification, after receiving the consult notification, and generating and sending an instruction notification including instruction information according to user input information, the instruction information including physical address information of the terminal device and information of whether allowing to access the network.

30. The system according to claim 9, wherein the network access device performing a consult operation according to the connection establishment request message comprises:
performing the consult operation when the network access device determines the terminal device does not have an access right according to the physical address information of the terminal device carried in the connection establishment request message.

31. The system according to claim 9, wherein the consult operation further comprises: the network access device assigning a network address for the terminal device, and the network address belonging to a network segment in an isolation area which cannot access the Internet.

32. The system according to claim 9, wherein the network access device has a login password or does not have the login password;
when the network access device does not have the login password, it claims to the external that it has the login password by broadcasting.

33. The system according to claim 9, wherein generating the consult notification according to the received consult message comprises:
obtaining the information carried in the consult message and sending the information to the main control device by instant message or short message or Email.

34. The system according to claim 9, wherein, when the main control device is directly connected to the network access device, the main control device directly sends the indication notification to the network access device; or
the main control device sends the indication notification to the server, the server generates an indication message according to the instruction information carried in the indication notification and sends the indication message to the network access device.

35. The system according to claim 9, wherein the consult message further comprises: a host name of the terminal device or the type of the terminal device, and the host name of the terminal device or the type of the terminal device is transmitted to the main control device via the indication notification.

36. The system according to claim 9, wherein performing the network access operation comprises:
connecting the terminal device into network, and isolating the terminal device in the isolation area; or
connecting the terminal device into network, and not isolating the terminal device in the isolation area.
